(19) United States
(12) Patent Application Publication
(10) Pub. No.: US 2015/0156200 A1
(43) Pub. Date: Jun. 4, 2015

(54) APPARATUS AND METHOD FOR SECURE AND SILENT CONFIRMATION-LESS PRESENCE FOR PUBLIC IDENTITIES

(71) Applicant: SAMSUNG ELECTRONICS CO., LTD., SUWON-SI (KR)

(72) Inventors: Xiang SUN, San Jose, CA (US); Luyi WANG, San Jose, CA (US); Eui-Suk CHUNG, Cupertino, CA (US); Bing XIA, Palo Alto, CA (US); Peter KING, San Mateo, CA (US)

(73) Assignee: SAMSUNG ELECTRONICS CO., LTD., SUWON-SI (KR)

(21) Appl. No.: 14/093,282

(22) Filed: Nov. 29, 2013

(51) Int. Cl. H04L 29/06; H04L 29/08

(52) U.S. Cl. CPC H04L 63/10; H04L 67/24

(57) ABSTRACT

An apparatus and method for providing access to a first user's public identity in a communication network are provided. The method includes receiving, from the first user, a first request message for at least one second user connection, receiving, from the at least one second user, a second request message for a first user connection, and providing, by the system server, access to the first user's public identity for the at least one second user and sharing the at least one second user's respective public identity with the first user.

### BACKGROUND OF THE INVENTION

1. Field of the Invention

The present disclosure relates to an apparatus and method for secure and silent confirmation-less presence detection for public identities. More particularly, the present disclosure relates to an apparatus and method for providing information on a presence of a user's public identity in a secure and silent manner.

2. Description of the Related Art

Mobile terminals are developed to provide wireless communication between users. As technology has advanced, mobile terminals now provide many additional features beyond simple telephone conversations. For example, mobile terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, social networking services, and many more. Mobile terminals are commonly used in many aspects of daily life with the plurality of features now provided.

For example, a mobile terminal provides portability and communication access in a wide variety of locations, and the mobile terminal may be kept with, on, and/or proximate to a user of the mobile terminal. Furthermore, a location of a mobile terminal may be determined such that when the mobile terminal is proximate to the user, a location of the user of the mobile terminal may be determined. Furthermore, mobile terminals are commonly used to provide access to and manage public identities and features of public identities in social networks. While providing an ability to manage and/or view a user's public identity, which may include a profile, a user account, a user identity, a website, a public document, or any other similar and/or suitable item or entity providing a public profile that is accessible to other users, the mobile terminal may provide information on a presence of a user that is accessible to other users. A presence of another user may be determined according to at least one of whether an entity, such as a server in a communication network, determines the status of a public identity to be online, rather than offline, and whether the entity determines that the public identity is to be presented to other users in a manner that indicates a distance of a user of the public identity. The distance of a user may be at least one of a physical distance that is determined according to at least approximate distances between mobile terminals of respective users and a social distance which may be any suitable metric indicating a relationship between two users having public identities.

Accordingly, a user of a public identity may have their presence confirmed by the entity and the entity may provide public information on the presence of the user. When managing the public identity, a user having the public identity may have to confirm that each and every other user that may access the pubic identity has an ability to view the information of the presence of the user having the pubic identity. Thus, according to the related art, presence confirmations may be heavy-weight such that they may need a user to perform several steps in order to perform the presence confirmation. For example, a related art presence confirmation may need both parties to perform bi-lateral confirmation in order to add and confirm each contact.

Alternatively, in order to perform a presence confirmation, social networks may use a “follow” model to determine if a user is interested in following another user's online activities without performing a bi-lateral confirmation. In such a case, it may be more efficient to assume every person that is added to a contact list, or that is added as people a user follows, is permitted to know a user's presence such that a presence confirmation is automatically conducted. Thus, whenever a user adds another user and/or person to a contact list and/or a follow list, the other user and/or person may know whether the user is present if the other user and/or person is also following the user. However, the user may prefer to not have another user know their presence while still allowing another user to follow the user and/or be on a contact of the user.

Accordingly, there is a need for a presence confirmation method and/or system and apparatus for confirming and/or providing permission for another user to be aware of a user's presence.

### SUMMARY OF THE INVENTION

Aspects of the present disclosure are to address at least the above-mentioned problems and/or disadvantages and to provide at least the advantages described below. Accordingly, an aspect of the present disclosure is to provide an apparatus and method for providing information on a presence of a user's public identity in a secure and silent manner.

In accordance with an aspect of the present disclosure, a method for providing access to a first user's public identity in a communication network is provided. The method includes receiving, from the first user, a first request message for at least one second user connection, receiving, from the at least one second user, a second request message for a first user connection, and providing, by the system server, access to the first user's public identity for the at least one second user and sharing the at least one second user's respective public identity with the first user.

In accordance with another aspect of the present disclosure, an apparatus for providing access to a first user's public identity in a communication network is provided. The apparatus includes a transceiver configured to receive, from the first user, a first request message for at least one second user connection, and configured to receive, from the at least one second user, a second request message for a first user connection, and a controller configured to provide access to the first user's public identity with the at least one second user and sharing the at least one second user's respective public identity with the first user.

In accordance with an aspect of the present disclosure, a method for providing access to a user's public identity in a communication network is provided. The method includes receiving, from a requestor, a presence confirmation request message corresponding to the user's public identity, determining an identity of the requestor, determining whether the requestor has permission to access the user's public identity, providing, to the requestor, access to the user's public identity if the requestor has permission to access the user's public identity, and transmitting, to the requestor, notification that the requestor has access to the user's public identity.

In accordance with another aspect of the present disclosure, a server for providing access to a user's public identity in a communication network is provided. The server includes a transceiver configured to receive, from a requestor, a presence confirmation request message corresponding to the user's public identity, and configured to transmit, to the requestor, notification that the requestor has access to the user's public identity, and a controller configured to determine an identity of the requestor, and configured to determine whether the requestor has permission to access the user's public identity, wherein the controller provides, to the requestor, access to the user's public identity if the request has permission to access the user's public identity.

In accordance with an aspect of the present disclosure, a method for providing access to a user's public identity in a communication network is provided. The method includes transmitting, from an inviter, an invite request message to at least one other user and a system server, receiving, by the system server, the invite request message and at least one invite acceptance message from the at least one other user, determining, by the system server, an identity of the inviter and respective identities of the at least one other user, and providing, to the at least one other user, access to the inviter's public identity.

In accordance with another aspect of the present disclosure, a server for providing access to a user's public identity in a communication network is provided. The apparatus includes a receiver configured to receive an invite request message from an inviter and at least one invite acceptance message from at least one other user, and a controller configured to determine an identity of the inviter and respective identities of the at least one other user, and configured to provide, to the at least one other user, access to the inviter's public identity.

Other aspects, advantages, and salient features of the invention will become apparent to those skilled in the art from the following detailed description, which, taken in conjunction with the annexed drawings, discloses embodiments of the invention.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a mobile terminal according to an embodiment of the present disclosure;

FIG. 2 illustrates a wireless communication system providing a presence confirmation method according to an embodiment of the present disclosure; and

FIG. 3 illustrates a method of providing presence confirmation according to an embodiment of the present disclosure.

FIG. 4 illustrates a request peer method of providing presence confirmation according to an embodiment of the present disclosure.

FIG. 5 illustrates a collaborator method of providing presence confirmation according to an embodiment of the present disclosure.

Throughout the drawings, it should be noted that like reference numbers are used to depict the same or similar elements, features, and structures.

### DETAILED DESCRIPTION OF EMBODIMENTS

The following description with reference to the accompanying drawings is provided to assist in a comprehensive understanding of embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of embodiments of the present disclosure are provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Embodiments of the present disclosure include an apparatus and method for providing presence confirmation according to an embodiment of the present disclosure.

According to an embodiment of the present disclosure, a presence confirmation method wherein a system brokers and silently holds onto a connection request is provided. Accordingly, when requests for presence confirmation are bi-lateral, both users are able to view the presence of each other.

More particularly, a presence confirmation may be used to and and/or confirm a contact to be included in a contact list corresponding to the user's social identity.

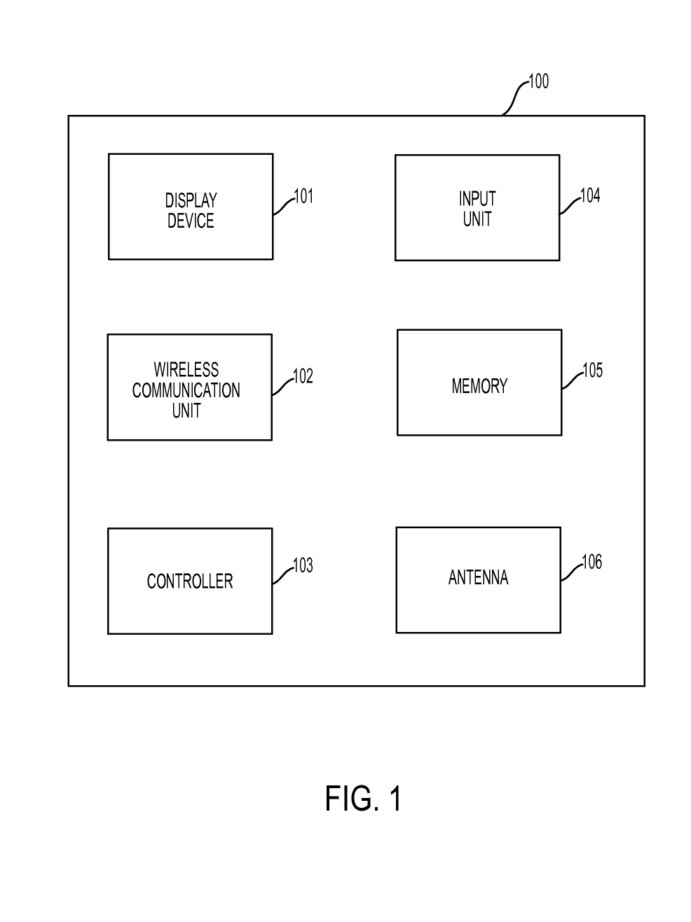

FIG. 1 illustrates a mobile terminal according to an embodiment of the present disclosure.

Referring to FIG. 1, a mobile terminal 100 may include a display device 101, a wireless communication unit 102, a controller 103, an input unit 104, a memory 105, and an antenna 106. The display device 101 may display information for a user of the mobile terminal 100, such as a variety of screens, multimedia content, graphics, and other information. The display unit may be a Liquid Crystal Display (LCD) device, a Light Emitting Diode (LED) display device, Organic LED (OLED) display device, a Thin Film Transistor (TFT) display device, or any other similar and/or suitable display device for displaying information.

The input unit 104 may be configured to receive a user's input for executing operations of and to input information to the mobile terminal 100. The input unit 104 may be a keyboard, a button, a touch input device such as a touch screen, a touch pad, or any other similar and/or suitable touch input device and/or input device. Furthermore, although not shown in the mobile terminal 100, the display device 101 and the input unit 104 may be formed as one unit for displaying information and receiving the user's input, such that the mobile terminal 100 is a touch screen device including a touch screen unit and a display device.

The wireless communication unit 102 may be configured to transmit and/or receive wireless radio communication signals, such as Radio Frequency (RF) signals and may include other radio communication elements that are not shown in FIG. 1, such as a Digital-to-Analog Converter (DAC) configured to convert digital signals to analog signals and to convert analog signals to digital signals, a transmitter configured to transmit signals, a receiver configured to receive signals, a modem configured to modulate and demodulate signals transmitted and/or received by the transmitter and/or receiver, and any other similar and/or suitable elements used for radio communications with a wireless network and/or other radio communication devices, such as other portable terminals, transmitting and/or receiving radio communication signals. Furthermore, the wireless communication unit 102 may be a Multi-Input Multi-Output (MIMO) device and may include more than one antenna.

The memory 105 may be configured to store data used and generated by the user of the mobile terminal 100 and may also store applications, a phonebook, multimedia contents, operations and executable commands, and any other data and/or information used in or generated by the operation of the mobile terminal 100. For example, the memory 105, according to the embodiment of the present disclosure, may include and/or store a contact list, which may include a list of family, friends, professional contacts and/or associates, classmates, community members, persons following a user and/or a user account, and persons and or public identities followed by a user, or any other similar and/or suitable group of persons known to and/or associated with the user of the mobile terminal and/or a public identity that may be managed through the mobile terminal.

The controller 103 may be configured to control overall operations of the mobile terminal 100, including other elements and operations of the mobile terminal shown in FIG. 1. For example, the controller may control operations of a presence confirmation method of the embodiment of the present disclosure.

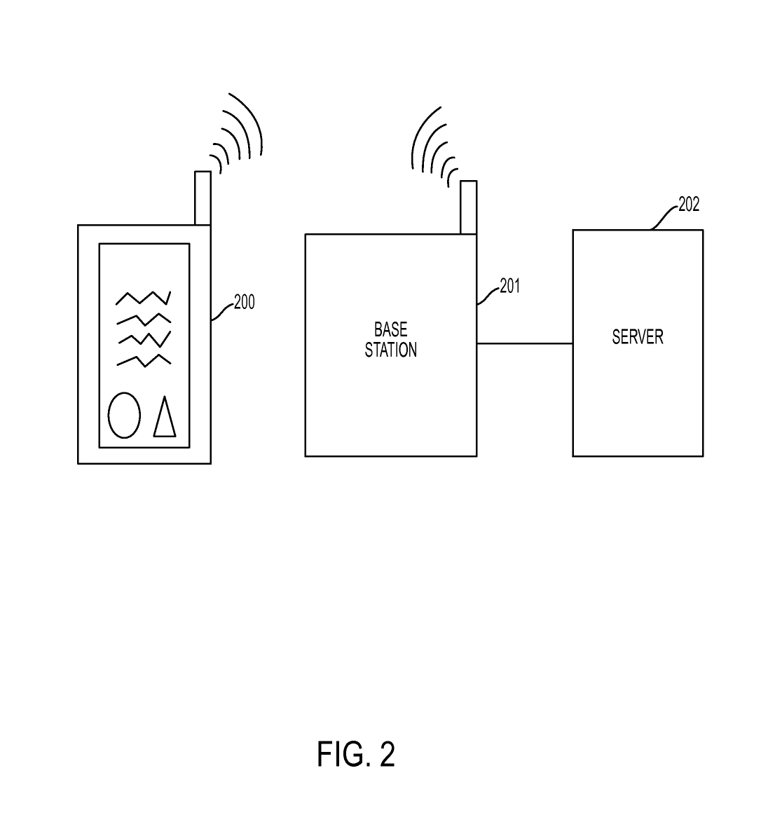

FIG. 2 illustrates a wireless communication system providing a presence confirmation method according to an embodiment of the present disclosure.

Referring to FIG. 2, the wireless communication system includes a mobile terminal 200, a Base Station (BS) 201, and a server 202. The mobile terminal 200 may be similar to the mobile terminal 100, and accordingly, a detailed description thereof will be omitted herein for the purpose of brevity.

The BS 201 may include elements not shown in FIG. 2, such as at least one antenna, at least one wireless transceiver and/or transmitters and receivers configured to transmit and/or receive RF signals, at least one fixed line communication transceiver configured to communicate using a wired communication method, a controller configured to control overall operations of the BS 201, and a memory configured to store information corresponding to the BS 201 and operations of the BS 201. The base station may include any number of additional structural elements. However, a description of additional structural elements of the base station is omitted for conciseness.

In further detail, the controller controls overall operations of the BS 201. The operations of the BS 201 may include any of the operations explicitly or implicitly described above as being performed by a BS. In addition, the controller may generate data to be transmitted from the BS 201 and may process data received by the BS 201. The memory may store programs and/or data used by controller for the operations of the BS 201 and may also store various data including any of the information and/or algorithms discussed herein as being received, transmitted, retained or used by a BS.

The server 202 may provide a plurality of services related to public identities and social networks, including presence confirmation, according to the present disclosure. For example, the server 202 may provide presence confirmation according to at least one of a request peer method and a collaborator method. The request peer method may also be referred to as a follower model, a peer method, and a peer discovery method, and may include discovering, locating, or finding a peer in the same environment, group, network, virtual network, social network, physical network, and/or carrier network as the requestor, providing presence confirmation without requiring users, which correspond to respective public identities, to confirm the sharing of their respective public identities with each other. The collaborator method may include providing presence confirmation according to information received from users, which correspond to respective public identities, wherein the information corresponds to confirming of the sharing of their respective public identities with each other.

Furthermore, the server 202 may be included in the BS 201 or may be a separate entity. The server 202 may be a hardware apparatus that includes at least one processor (not shown) and a body (not shown) that encloses the at least one processor. The server 202 may also be dispersed across more than one physical location and, thus, may include in more than one processor and more than one body. Additionally, the server 202 may include other elements that are not shown, such as a wireless communication unit, a wired communication unit, a display device, an input device, and any other similar and/or suitable elements that may be included in the server 202.

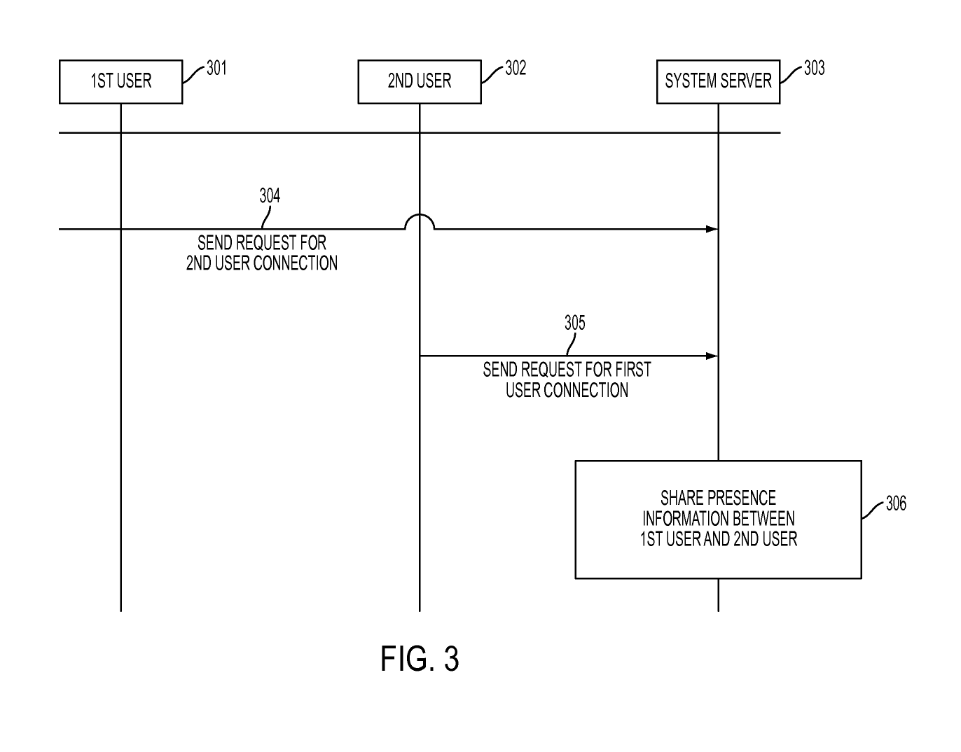

FIG. 3 illustrates a method of providing presence confirmation according to an embodiment of the present disclosure.

Referring to FIG. 3, a first user 301, a second user 302 and a system server 303 are included in a system for providing a presence confirmation method according to an embodiment of the present disclosure. In operation 304, the first user 301 sends a request for a connection of a second user 302 to the system server 303. In other words, the first user 301 requests a connection to the second user 302 that would allow for a presence confirmation of the second user 302. In operation 305, the second user 302 sends a request for a connection of a first user 302 to the system server 303. Although the present embodiment shows operation 305 occurring after operation 304, the present disclosure is not limited thereto, and operation 304 and operation 305 may be performed in any similar and/or suitable manner and/or order. After the system server 303 receives a request for respective connections from both of the first user 301 and the second user 302, the system server 303, in operation 306, shares presence information between the first user 301 and the second user 302. Additionally, according to an embodiment of the present disclosure, the system server 303 may share the presence information between the first user 301 and the second user 302 as long as the first user 301 and the second user 302 maintain each other in their respective contact lists.

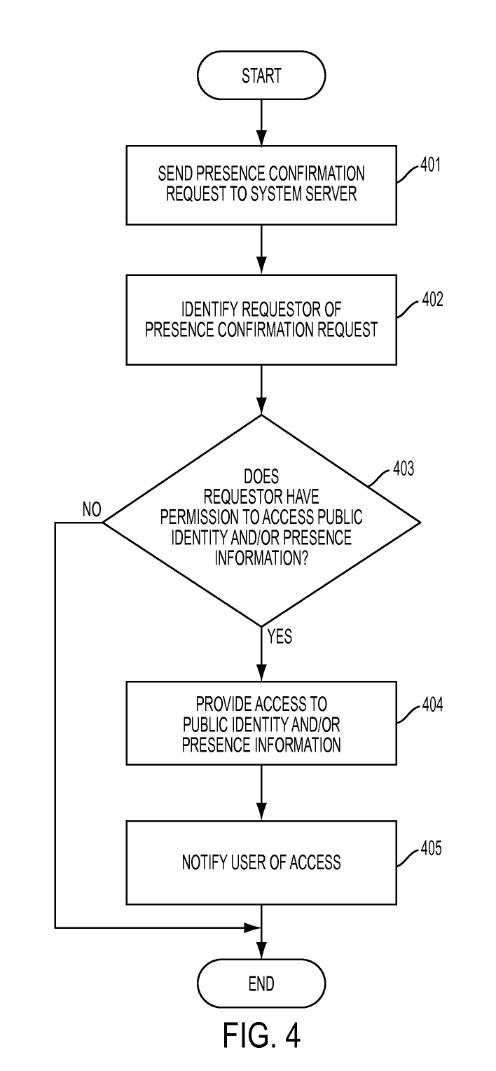

FIG. 4 illustrates a request peer method of providing presence confirmation according to an embodiment of the present disclosure.

Referring to FIG. 4, a first user, a second user and a system server are included in a system for providing a presence confirmation method according to an embodiment of the present disclosure. As shown in FIG. 4, the request peer method of providing presence confirmation, according to an embodiment of the present disclosure, does not require users, which respectively correspond to a public identity, to confirm sharing of the public identities with each other user that requests access to the public identity. In operation 401, the first user sends a presence confirmation request to the system server. The presence confirmation request may be any suitable message type that includes information on a certain public identity and information corresponding to a request for granting the first user access to the certain public identity.

Next, after the system server receives the presence confirmation request sent by the first user in operation 401, the system server, in operation 402, identifies a requestor of the presence confirmation request. For example, the system server may identify the first user to be the requestor of the presence confirmation request sent in operation 401. The system server may determine the identity of the requestor of the presence confirmation request by any suitable means, such as a case where the system server determines the requestor by reviewing identification information included in a header of the message having the presence confirmation request or by reviewing any suitable and/or similar information identifying the requestor of the presence confirmation request.

Next, in operation 403, the system server determines whether the requestor, such as the first user of the presence confirmation request, has permission to access the certain public identity and/or presence information corresponding to the certain public identity. However, the present disclosure is not limited thereto, and the any other similar and/or suitable network entity, other than the system server, may determine whether the requestor has permission to access the certain public identity and/or presence information corresponding to the certain public identity.

Furthermore, it may be determined, by the system server or the other similar and/or suitable network entity, whether the requestor has permission to access the certain public identity, and/or presence information corresponding to the certain public identity, according to a variety of methods, such as, but not limited to, determining whether the requestor is included in a database, a list, or any other collection of information, determining whether information corresponding to the requestor is included in a database, a list, or any other collection of information, providing, by the requestor and/or any other network entity, information indicating whether the requestor has permission to access the certain public identity and/or presence information corresponding to the certain public identity, is included in a database, a list, or any other collection of information, and any other similar and/or suitable method for determining whether the requestor has permission to access the certain public identity, and/or presence information corresponding to the certain public identity.

Upon determining that the first user has permission to access the certain public identity and/or the presence information, the system sever, in operation 404, provides the first user access to the certain public identity and/or the presence information. Next, in operation 405, the system server informs the first user of the granted access, and the first user may be informed of the presence of a user having a public identity. For example, the system server may transmit a presence confirmation response to the first user The presence confirmation response may include information identifying the public profile, a time stamp that may indicate when access has been granted to the first user i.e., when the contact between the first user and the public identity was created, and information on a type of access or a type of permission granted to the first user for accessing the public identity and/or information included in the public identity. However, the present disclosure is not limited thereto, and the presence confirmation response may include any suitable and/or similar information.

Furthermore, if the first user is granted access to the certain public identity and/or the presence information by the system server, then the system server may also provide a user corresponding to the certain public identity and/or the presence information access to the public identity and/or the presence information corresponding to the first user In other words, upon the first user getting or being granted access to another user's public identity and/or presence information, then the other user may get and/or be granted access to the public identity and/or presence information of the first user.

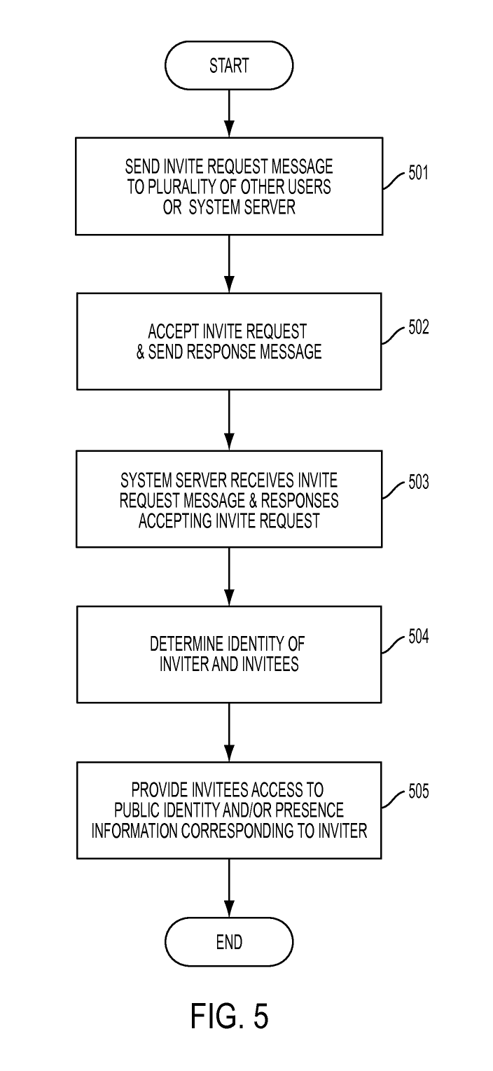

FIG. 5 illustrates a collaborator method of providing presence confirmation according to an embodiment of the present disclosure.

Referring to FIG. 5, a first user, a second user and a system server are included in a system for providing a presence confirmation method according to an embodiment of the present disclosure. As shown in FIG. 5, in operation 501, the first user sends an invite request message to a plurality of other users, including the second user. However, the present disclosure is not limited thereto, and the first user may send the invite request message to any suitable destination, such as the system server. In such a case, the system server may record and/or store information identifying each of the plurality of other users. The invite request message may be to invite the other users to have access to a public identity and/or presence information corresponding to the first user, which sends the invite request message. The invite request message may include information on identities of the other users that are invited to have access to the public identity and/or presence information and information on a type of invitation sent by the first user.

For example, the type of invitation may vary according to how much access the first user is inviting the plurality of other users to have, and may vary respectively for each of the plurality of other users. After receiving the invite request message sent from the first user in operation 501, then, in operation 502, any of the plurality of other users may accept the invite request sent by the first user. However, the present disclosure is not limited thereto, and operation 502 may be an optional operation and may not be excluded from the operations illustrated in FIG. 5. As such, according to an embodiment of the present disclosure, after the first user has transmitted the invite request message to any of the plurality of other users, each of the plurality of other users may be able to access the public identity and/or presence information corresponding to the first user without having to accept the invitation sent by the first user via the invite request message.

Furthermore, according to another embodiment, the second user and/or any of the plurality of other users may be granted access to the public identity but may not have access to presence information, or any other type of privately shared information, of the first user. In such a case, the first user may invite the second user and/or any of the plurality of other users to access to the privately shared information, and the privately shared information may only be accessible to the second user and/or any of the plurality of other users after accepting the invitation from the first user.

Next, in operation 503, the system server may receive at least one of the invite request message sent by the first user and any responses to the invite request message sent by any of the plurality of other users. Furthermore, the system server may identify the inviter sending the invite request message, and as shown in FIG. 5, the system server may identify the inviter sending the invite request message to be the first user. The system server, in operation 504, may determine the identity of the inviter sending the invite request message by any suitable means, such as a case where the system server determines the inviter by reviewing identification information included in a header of the message having the presence confirmation request or by reviewing any suitable and/or similar information identifying the inviter of the presence confirmation request. Additionally, the system server may identify the users included in the plurality of other users according to the information included in the invite request message transmitted by the first user.

Upon identifying both the inviter and the invitees included in the invite request message sent by the first user, in operation 504, then, the system server, in operation 505, may provide each of the plurality other users, including the second user, access to the certain public identity and/or the presence information corresponding to the inviter, which may be the first user, as shown in FIG. 5. However, the present disclosure is not limited thereto, and the inviter included in the invite request message may be different than the device and/or user, such as the first user, that transmits the invite request message. In further detail, the system server may create an item or an element, such as an entry in an access database, indicating that any of the plurality of other users has access to the certain public identity and/or the presence information corresponding to the inviter, such as the first user.

Additionally, the system server may also determine whether any of the plurality of other users has already been granted access to the certain public identity and/or the presence information corresponding to the inviter by reviewing a database, such as the access database. Thus, the certain public identity and/or presence information may be provided to any of the plurality of other users without the first user having to confirm that each of the plurality of other users has permission to access the certain public identity and/or the presence information corresponding to the inviter.

While the invention has been shown and described with reference to certain embodiments thereof, it will be understood by those skilled in the art that various changes in form and details may be made therein without departing from the spirit and scope of the invention as defined by the appended claims and their equivalents.

More particularly, the present disclosure relates to an apparatus and method for providing information on a presence of a user's public identity in a secure and silent manner that does not require users to confirm sharing of the public identities.

What is claimed is:

1. A method for providing access to a first user's public identity in a communication network, the method comprising:
receiving, from the first user, a first request message for at least one second user connection;
receiving, from the at least one second user, a second request message for a first user connection; and
providing, by the system server, access to the first user's public identity for the at least one second user and sharing the at least one second user's respective public identity with the first user.

2. The method of claim 1, wherein the public identity includes presence information corresponding to the user's presence.

3. The method of claim 2, wherein the presence information includes at least one of information indicating a status of a public identity to be at least one of online and offline, and information on whether the public identity is to be presented to other users so as to indicate a distance of the user.

4. The method of claim 3, wherein the distance of the user may be at least one of a physical distance that is determined according to an approximate distance between a mobile terminal of the first user and a mobile terminal of the at least one second user and a social distance that indicates a relationship between the first user and the at least one second user.

5. The method of claim 1, wherein the system server provides the access to the first user's public identity for the at least one second user without requesting the first user to grant access to the first user's public identity if the system server has received, from the first user, the first request message for the at least one second user connection.

6. The method of claim 1, wherein the system server provides the access to the at least one second user's public identity for the first user without requesting the at least one second user to grant access to the at least one second user's public identity if the system server has received, from the at least one second user, the second request message for the first user connection.

7. A server for providing access to a first user's public identity in a communication network, the server comprising:
a transceiver configured to receive, from the first user, a first request message for at least one second user connection, and configured to receive, from the at least one second user, a second request message for a first user connection; and
a controller configured to provide access to the first user's public identity with the at least one second user and sharing the at least one second user's respective public identity with the first user.

8. The server of claim 7, wherein the public identity includes presence information corresponding to the user's presence.

9. The server of claim 8, wherein the presence information includes at least one of information indicating a status of a public identity to be at least one of online and offline, and information on whether the public identity is to be presented to other users so as to indicate a distance of the user.

10. The server of claim 9, wherein the distance of the user may be at least one of a physical distance that is determined according to an approximate distance between a mobile terminal of the first user and a mobile terminal of the at least one second user and a social distance that indicates a relationship between the first user and the at least one second user.

11. A method for providing access to a user's public identity in a communication network, the method comprising:
receiving, from a requestor, a presence confirmation request message corresponding to the user's public identity;
determining an identity of the requestor;
determining whether the requestor has permission to access the user's public identity;
providing, to the requestor, access to the user's public identity if the requestor has permission to access the user's public identity; and
transmitting, to the requestor, notification that the requestor has access to the user's public identity.

12. The method of claim 11, wherein the presence information includes at least one of information indicating a status of a public identity to be at least one of online and offline, and information on whether the public identity is to be presented to other users so as to indicate a distance of the user.

13. The method of claim 12, wherein the distance of the user may be at least one of a physical distance that is determined according to an approximate distance between a mobile terminal of the first user and a mobile terminal of the at least one second user and a social distance that indicates a relationship between the first user and the at least one second user.

14. The method of claim 11, wherein the system server provides the access to the first user's public identity for the at least one second user without requesting the first user to grant access to the first user's public identity if the system server has received, from the first user, the first request message for the at least one second user connection.

15. The method of claim 11, wherein the system server provides the access to the at least one second user's public identity for the first user without requesting the at least one second user to grant access to the at least one second user's public identity if the system server has received, from the at least one second user, the second request message for the first user connection.

16. A server for providing access to a user's public identity in a communication network, the server comprising:
a transceiver configured to receive, from a requestor, a presence confirmation request message corresponding to the user's public identity, and configured to transmit, to the requestor, notification that the requestor has access to the user's public identity; and
a controller configured to determine an identity of the requestor, and configured to determine whether the requestor has permission to access the user's public identity,
wherein the controller provides, to the requestor, access to the user's public identity if the request has permission to access the user's public identity.

17. The server of claim 16, wherein the public identity includes presence information corresponding to the user's presence.

18. The server of claim 17, wherein the presence information includes at least one of information indicating a status of a public identity to be at least one of online and offline, and information on whether the public identity is to be presented to other users so as to indicate a distance of the user.

19. The server of claim 18, wherein the distance of the user may be at least one of a physical distance that is determined according to an approximate distance between a mobile terminal of the first user and a mobile terminal of the at least one second user and a social distance that indicates a relationship between the first user and the at least one second user.

20. A method for providing access to a user's public identity in a communication network, the method comprising:
transmitting, from an inviter, an invite request message to at least one other user and a system server;
receiving, by the system server, the invite request message and at least one invite acceptance message from the at least one other user;
determining, by the system server, an identity of the inviter and respective identities of the at least one other user; and
providing, to the at least one other user, access to the inviter's public identity.

21. The method of claim 20, wherein the public identity includes presence information corresponding to the user's presence.

22. The method of claim 21, wherein the presence information includes at least one of information indicating a status of a public identity to be at least one of online and offline, and information on whether the public identity is to be presented to the at least one other user so as to indicate a distance of the user.

23. The method of claim 22, wherein the distance of the user may be at least one of a physical distance that is determined according to an approximate distance between a mobile terminal of the user and a mobile terminal of the at least one other user and a social distance that indicates a relationship between the user and the at least one other user.

24. A server for providing access to a user's public identity in a communication network, the server comprising:
a receiver configured to receive an invite request message from an inviter and at least one invite acceptance message from at least one other user; and
a controller configured to determine an identity of the inviter and respective identities of the at least one other user, and configured to provide, to the at least one other user, access to the inviter's public identity.
